(19) United States
(12) Patent Application Publication
(10) Pub. No.: US 2022/0198146 A1
(43) Pub. Date: Jun. 23, 2022

(54) SYSTEM AND METHOD FOR END-TO-END NEURAL ENTITY LINKING

(71) Applicant: JPMorgan Chase Bank, N.A., New York, NY (US)

(72) Inventors: Wanying DING, Sunnyvale, CA (US); Vinay K. CHAUDHRI, Sunnyvale, CA (US); Naren CHITTAR, Saratoga, CA (US); Krishna KONAKANCHI, Lewis Center, OH (US)

(73) Assignee: JPMorgan Chase Bank, N.A., New York, NY (US)

(21) Appl. No.: 17/643,501

(22) Filed: Dec. 9, 2021

Related U.S. Application Data
(60) Provisional application No. 63/126,838, filed on Dec. 17, 2020.

(51) Int. Cl. G06F 40/295; G06N 5/02; G06N 3/04

(52) U.S. Cl. CPC G06F 40/295; G06N 3/0454; G06N 5/02

(57) ABSTRACT

Various methods, apparatuses/systems, and media for end-to-end entity linking are disclosed. The system includes a processor; and a memory operatively connected to the processor via a communication interface, the memory storing computer readable instructions, when executed, causes the processor to: detect all named entity mentions from a plurality of data sources; compute, in response to detecting, entity embeddings in a knowledge graph by implementing context information and a margin-based loss function; validate the entity embeddings; deploy, in response to validating the entity embeddings, a machine learning model to match character and semantic information, respectively; and link, in response to deployment of the wide and deep learning model, the named mentions in text with corresponding entities in the knowledge graph.

### CROSS-REFERENCE TO RELATED APPLICATIONS

This application claims the benefit of priority from U.S. Provisional Patent Application No. 63/126,838, filed Dec. 17, 2020 which is herein incorporated by reference in its entirety.

### TECHNICAL FIELD

This disclosure generally relates to data processing, and, more particularly, to methods and apparatuses for implementing an end-to-end neural entity linking module configured for generating entity embeddings, and utilizing a machine learning model to match character and semantic information respectively.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Knowledge Graphs have emerged as a compelling abstraction for capturing key relationship among the entities of interest to enterprises and for integrating data from heterogeneous sources. Knowledge graphs may be leveraged across an organization for multiple mission critical applications such as risk assessment, fraud detection, investment advice, etc. A core problem, however, in leveraging a knowledge graph is to link mentions (e.g., company names, person names, etc.) that are encountered in textual sources to entities in the knowledge graph.

Although several conventional techniques exist for entity linking, they are tuned for entities that exist in Wikipedia, and fail to generalize for the entities that are of interest to an enterprise. For example, Wikipedia does not cover all the entities of financial interest; and lacks context information. Many pre-trained models may achieve great performance by leveraging rich context data from Wikipedia. However, for an organization's internal data, there may not be sufficient information comparable to Wikipedia to support re-training or fine-tuning of existing models. For example, conventional entity linking has been driven by a number of standard datasets, such as CoNLYAGO, TAC KBP, DBpedia, and ACE. These datasets are based on Wikipedia, and are therefore, naturally coherent, well-structured and rich in context. However, as mentioned above, the following problems, among others, may be faced when utilizing these methods for entity linking for a knowledge graph. For example, FIG. 9 illustrates a conventional example 900 for entity linking. Since Wikipedia does not cover all the entities of financial interest, the startup “Lumier” 902 mentioned in FIG. 9 is not present in Wikipedia, but it is of high financial interest as it has raised critical investment from famous investors.

Therefore, there is a need for an advanced tool that can address these conventional shortcomings.

### SUMMARY

The present disclosure, through one or more of its various aspects, embodiments, and/or specific features or sub-components, provides, among other features, various systems, servers, devices, methods, media, programs, and platforms for implementing a platform and language agnostic end-to-end neural entity linking module configured for generating entity embeddings, and utilizing a machine learning model (i.e., deep learning model) to match character and semantic information respectively, but the disclosure is not limited thereto.

For example, the various aspects, embodiments, features, and/or sub-components may also provide optimized processes of implementing a platform and language agnostic end-to-end neural entity linking module that is configured to: compute entity embeddings by training a margin loss function without relying on Wikipedia; and deploy a machine/deep learning model (i.e., wide and deep learning model) to match character and semantic information respectively, but the disclosure is not limited thereto.

According to an aspect of the present disclosure, a method for end-to-end neural entity linking by utilizing one or more processors and one or more memories is disclosed. The method may include: detecting all named entity mentions from a plurality of data sources; computing, in response to detecting, entity embeddings in a knowledge graph by implementing context information and a margin-based loss function; validating the entity embeddings; deploying, in response to validating the entity embeddings, a machine learning model to match character and semantic information, respectively; and linking, in response to deployment of the wide and deep learning model, the named mentions in text with corresponding entities in the knowledge graph.

According to another aspect of the present disclosure, in deploying the machine learning model, the method may further include: applying a linear layer to learn character patterns.

According to yet another aspect of the present disclosure, the method may further include: implementing a triplet loss model to generate the entity embeddings from pre-trained word embedding models.

According to a further aspect of the present disclosure, the method may further include: embedding the mentions into vectors; and mathematically measuring similarities between the mentions and corresponding entity embeddings based on the vectors.

According to an additional aspect of the present disclosure, the method may further include: implementing a cosine similarity algorithm to measure similarities between each mention and corresponding entity embedding, but the disclosure is not limited thereto. For example, the method may further include implementing an Euclidean distance to measure similarities between each mention and corresponding entity embedding.

According to yet another aspect of the present disclosure, the machine learning model may be a wide and deep learning model but the disclosure is not limited thereto.

According to a further aspect of the present disclosure, the wide and deep learning model may include a first long short-term memory (LSTM) neural network architecture configured to embed mentions from a first direction and a second LSTM neural network architecture configured to embed mentions from a second direction different from the first direction, but the disclosure is not limited thereto.

According to an aspect of the present disclosure, a system for end-to-end neural entity linking is disclosed. The system may include: a processor; and a memory operatively connected to the processor via a communication interface, the memory storing computer readable instructions, when executed, may cause the processor to: detect all named entity mentions from a plurality of data sources; compute, in response to detecting, entity embeddings in a knowledge graph by implementing context information and a margin-based loss function; validate the entity embeddings; deploy, in response to validating the entity embeddings, a machine learning model to match character and semantic information, respectively; and link, in response to deployment of the wide and deep learning model, the named mentions in text with corresponding entities in the knowledge graph.

According to another aspect of the present disclosure, in deploying the machine learning model, the processor may be further configured to apply a linear layer to learn character patterns.

According to yet another aspect of the present disclosure, the processor may be further configured to implement a triplet loss model to generate the entity embeddings from pre-trained word embedding models.

According to a further aspect of the present disclosure, the processor may be further configured to embed the mentions into vectors; and mathematically measure similarities between the mentions and corresponding entity embeddings based on the vectors.

According to an additional aspect of the present disclosure, the processor may be further configured to implement a cosine similarity algorithm to measure similarities between each mention and corresponding entity embedding.

According to an aspect of the present disclosure, non-transitory computer readable medium configured to store instructions for end-to-end neural entity linking is disclosed. The instructions, when executed, may cause a processor to perform the following: detecting all named entity mentions from a plurality of data sources; computing, in response to detecting, entity embeddings in a knowledge graph by implementing context information and a margin-based loss function; validating the entity embeddings; deploying, in response to validating the entity embeddings, a machine learning model to match character and semantic information, respectively; and linking, in response to deployment of the wide and deep learning model, the named mentions in text with corresponding entities in the knowledge graph.

According to another aspect of the present disclosure, in deploying the machine learning model, the instructions, when executed, may cause a processor to perform the following: applying a linear layer to learn character patterns.

According to yet another aspect of the present disclosure, the instructions, when executed, may cause a processor to perform the following: implementing a triplet loss model to generate the entity embeddings from pre-trained word embedding models.

According to a further aspect of the present disclosure, the instructions, when executed, may cause a processor to perform the following: embedding the mentions into vectors; and mathematically measuring similarities between the mentions and corresponding entity embeddings based on the vectors.

According to an additional aspect of the present disclosure, the instructions, when executed, may cause a processor to perform the following: implementing a cosine similarity algorithm to measure similarities between each mention and corresponding entity embedding.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform and language agnostic end-to-end neural entity linking module configured for generating entity embeddings, and utilizing a machine learning model to match character and semantic information respectively, in accordance with an exemplary embodiment.

FIG. 2 illustrates an exemplary diagram of a network environment with a platform and language agnostic end-to-end neural entity linking device in accordance with an exemplary embodiment.

FIG. 3 illustrates a system diagram for implementing a platform and language agnostic end-to-end neural entity linking device having a platform and language agnostic end-to-end neural entity linking module in accordance with an exemplary embodiment.

FIG. 4 illustrates a system diagram for implementing a platform and language agnostic end-to-end neural entity linking module of FIG. 3 in accordance with an exemplary embodiment.

FIG. 5 illustrates an exemplary use case of visualization and validation of entity embeddings implemented by the platform and language agnostic end-to-end neural entity linking module of FIG. 4 in accordance with an exemplary embodiment.

FIG. 6 illustrates an exemplary model framework implemented by the platform and language agnostic end-to-end neural entity linking module of FIG. 4 in accordance with an exemplary embodiment.

FIG. 7A illustrates an exemplary table illustrating performance comparison via precision and recall algorithm implemented by the platform and language agnostic end-to-end neural entity linking module of FIG. 4 in accordance with an exemplary embodiment.

FIG. 7B illustrates another exemplary table of performance comparison via precision and recall algorithm implemented by the platform and language agnostic end-to-end neural entity linking module of FIG. 4 in accordance with an exemplary embodiment.

FIG. 8 illustrates a flow chart for generating entity embeddings, and utilizing a machine learning model to match character and semantic information respectively, in accordance with an exemplary embodiment.

FIG. 9 illustrates a conventional example for entity linking.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

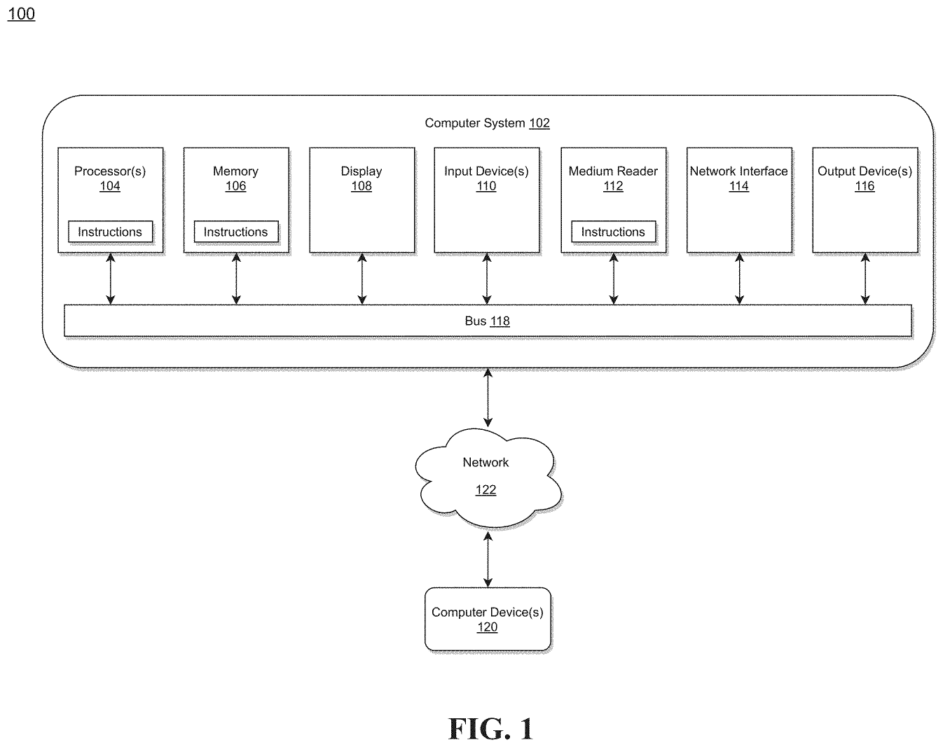

FIG. 1 is an exemplary system for use in implementing a platform and language agnostic end-to-end neural entity linking module configured for generating entity embeddings, and utilizing a machine learning model to match character and semantic information respectively in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and an operation mode having parallel processing capabilities. Virtual computer system processing can be constructed to implement one or more of the methods or functionality as described herein, and a processor described herein may be used to support a virtual processing environment.

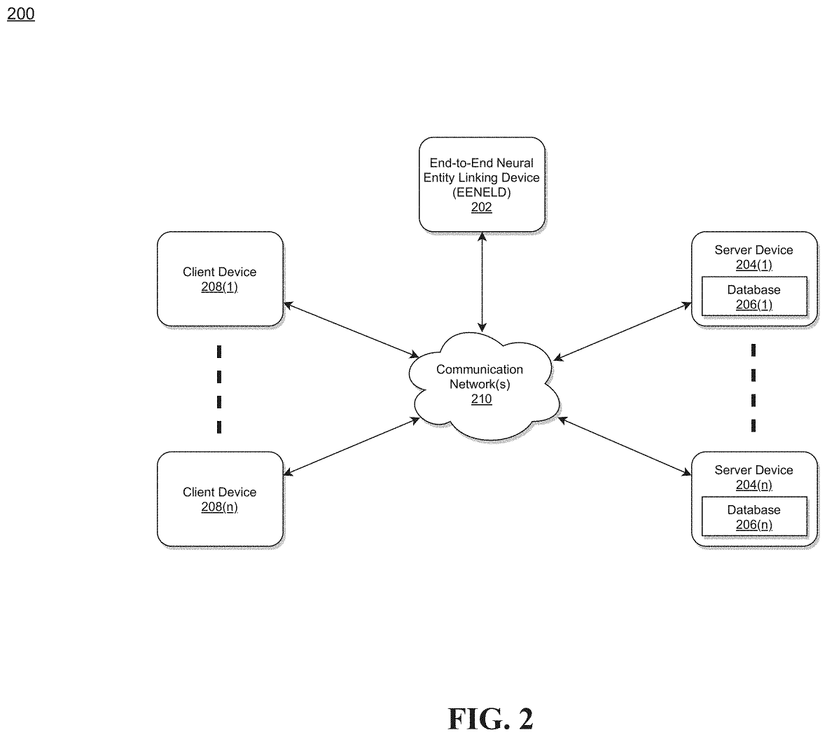

Referring to FIG. 2, a schematic of an exemplary network environment 200 for implementing with a platform and language agnostic end-to-end neural entity linking device (EENELD) of the instant disclosure is illustrated.

According to exemplary embodiments, the above-described problems associated with conventional approach of entity linking may be overcome by implementing a EENELD 202 as illustrated in FIG. 2 that may implement a platform and language agnostic end-to-end neural entity linking device module configured for generating entity embeddings, and utilizing a machine learning model (i.e., deep learning model) to match character and semantic information respectively, but the disclosure is not limited thereto.

The EENELD 202 may be the same or similar to the computer system 102 as described with respect to FIG. 1.

The EENELD 202 may store one or more applications that can include executable instructions that, when executed by the EENELD 202, cause the EENELD 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the EENELD 202 itself, may be located in virtual server(s) running in a cloud-based computing environment rather than being tied to one or more specific physical network computing devices. Also, the application(s) may be running in one or more virtual machines (VMs) executing on the EENELD 202. Additionally, in one or more embodiments of this technology, virtual machine(s) running on the EENELD 202 may be managed or supervised by a hypervisor.

In the network environment 200 of FIG. 2, the EENELD 202 is coupled to a plurality of server devices 204(1)-204(n) that hosts a plurality of databases 206(1)-206(n), and also to a plurality of client devices 208(1)-208(n) via communication network(s) 210. A communication interface of the EENELD 202, such as the network interface 114 of the computer system 102 of FIG. 1, operatively couples and communicates between the EENELD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the EENELD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 202 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The EENELD 202 may be a standalone device or integrated with one or more other devices or apparatuses, such as one or more of the server devices 204(1)-204(n), for example. In one particular example, the EENELD 202 may be hosted by one of the server devices 204(1)-204(n), and other arrangements are also possible. Moreover, one or more of the devices of the EENELD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the EENELD 202 via the communication network(s) 210 according to the HTTP-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

According to exemplary embodiments, the client devices 208(1)-208(n) in this example may include any type of computing device that can facilitate the implementation of the EENELD 202 that may efficiently provide a platform for implementing a platform and language agnostic end-to-end neural entity linking module configured for generating entity embeddings, and utilizing a machine learning model (i.e., wide and deep learning model) to match character and semantic information respectively, but the disclosure is not limited thereto.

The client devices 208(1)-208(n) may run interface applications, such as standard web browsers or standalone client applications, which may provide an interface to communicate with the EENELD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the EENELD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the EENELD 202, the server devices 204(1)-204(n), or the client devices 208(1)-208(n), for example, may be configured to operate as virtual instances on the same physical machine. For example, one or more of the EENELD 202, the server devices 204(1)-204(n), or the client devices 208(1)-208(n) may operate on the same physical device rather than as separate devices communicating through communication network(s) 210. Additionally, there may be more or fewer EENELDs 202, server devices 204(1)-204(n), or client devices 208(1)-208(n) than illustrated in FIG. 2. According to exemplary embodiments, the EENELD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

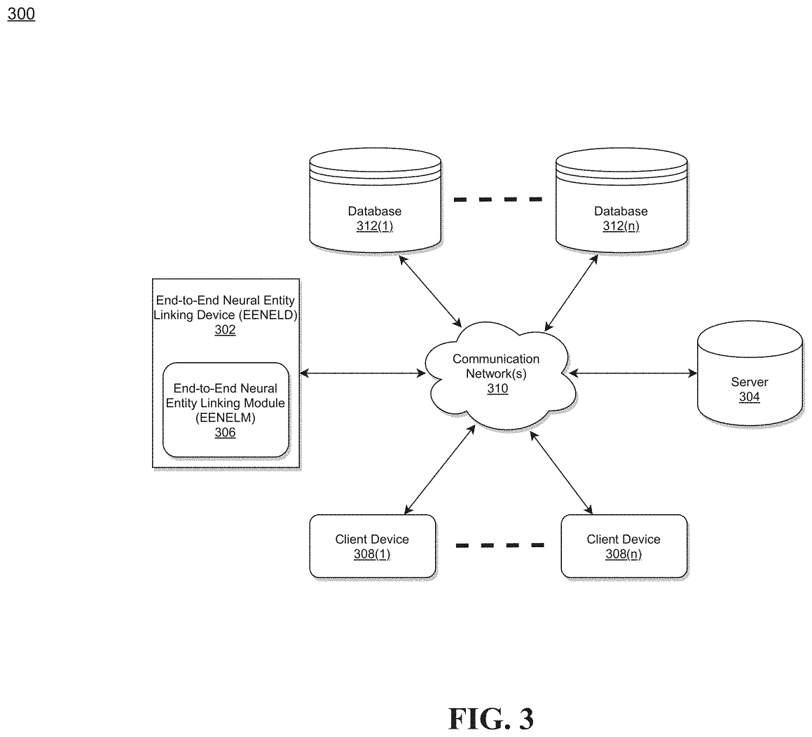

FIG. 3 illustrates a system diagram for implementing a platform and language agnostic EENELD having a platform and language agnostic end-to-end neural entity linking module (EENELM) in accordance with an exemplary embodiment.

As illustrated in FIG. 3, the system 300 may include an EENELD 302 within which an EENELM 306 is embedded, a server 304, a plurality of data sources 312(1) . . . 312(n), a plurality of client devices 308(1) . . . 308(n), and a communication network 310.

According to exemplary embodiments, the EENELD 302 including the EENELM 306 may be connected to the server 304, and the data sources 312(1) . . . 312(n) via the communication network 310. The EENELD 302 may also be connected to the plurality of client devices 308(1) . . . 308(n) via the communication network 310, but the disclosure is not limited thereto. According to exemplary embodiments, the data sources 312(1) . . . 312(n) may be disparate data sources, i.e., each data source may be different in type than the other data sources, but the disclosure is not limited thereto.

According to exemplary embodiment, the EENELD 302 is described and shown in FIG. 3 as including the EENELM 306, although it may include other rules, policies, modules, databases, or applications, for example. According to exemplary embodiments, the data sources 312(1) . . . 312(n) may be configured to store ready to use modules written for each API for all environments.

According to exemplary embodiments, the EENELM 306 may be configured to receive real-time feed of data from the plurality of client devices 308(1) . . . 308(n) via the communication network 310.

As will be described below, the EENELM 306 may be configured to detect all named entity mentions from a plurality of data sources; compute, in response to detecting, entity embeddings in a knowledge graph by implementing context information and a margin-based loss function; validate the entity embeddings; deploy, in response to validating the entity embeddings, a machine learning model to match character and semantic information, respectively; and link, in response to deployment of the wide and deep learning model, the named mentions in text with corresponding entities in the knowledge graph, but the disclosure is not limited thereto.

The plurality of client devices 308(1) . . . 308(n) are illustrated as being in communication with the EENELD 302. In this regard, the plurality of client devices 308(1) . . . 308(n) may be “clients” of the EENELD 302 and are described herein as such. Nevertheless, it is to be known and understood that the plurality of client devices 308(1) . . . 308(n) need not necessarily be “clients” of the EENELD 302, or any entity described in association therewith herein. Any additional or alternative relationship may exist between either or both of the plurality of client devices 308(1) . . . 308(n) and the EENELD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. According to exemplary embodiments, the server 304 may be the same or equivalent to the server device 204 as illustrated in FIG. 2.

The process may be executed via the communication network 310, which may comprise plural networks as described above. For example, in an exemplary embodiment, one or more of the plurality of client devices 308(1) . . . 308(n) may communicate with the EENELD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The EENELD 302 may be the same or similar to the EENELD 202 as described with respect to FIG. 2, including any features or combination of features described with respect thereto.

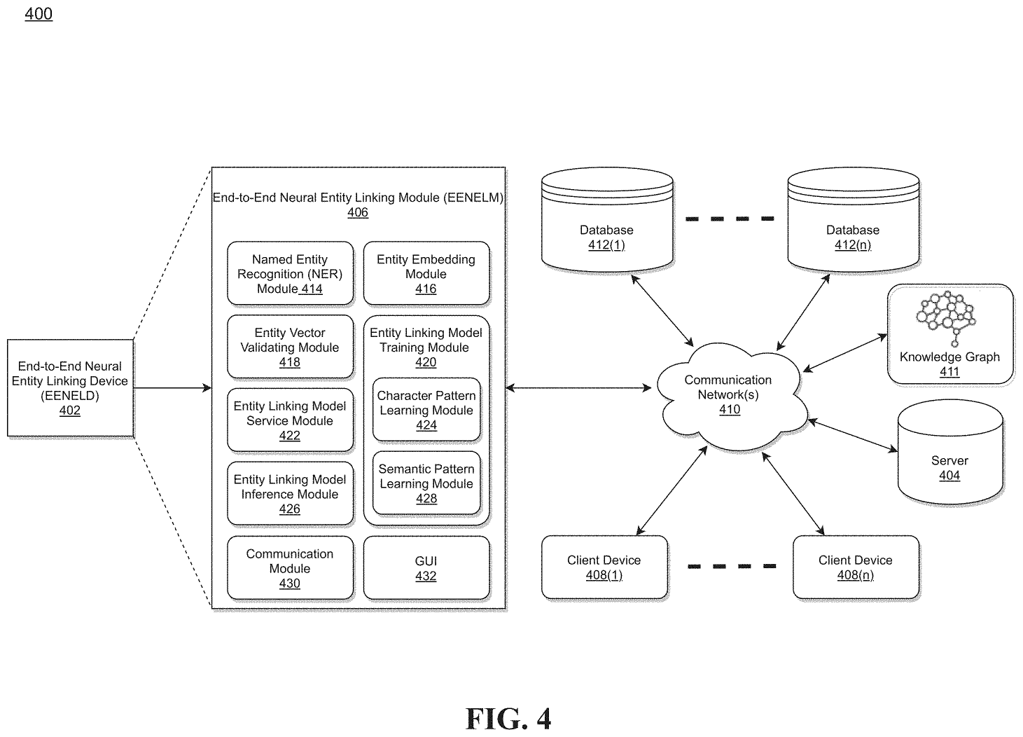

FIG. 4 illustrates a system diagram for implementing a platform and language agnostic EENELM of FIG. 3 in accordance with an exemplary embodiment.

According to exemplary embodiments, the system 400 may include a platform and language agnostic EENELD 402 within which an EENELM 406 is embedded, a server 404, data sources 412(1) . . . 412(n), a knowledge graph 411, and a communication network 410.

According to exemplary embodiments, the EENELD 402 including the EENELM 406 may be connected to the server 404, the knowledge graph 411, and the data sources 412(1) . . . 412(n) via the communication network 410. The EENELD 402 may also be connected to the plurality of client devices 408(1)-408(n) via the communication network 410, but the disclosure is not limited thereto. The EENELM 406, the server 404, the plurality of client devices 408(1)-408(n), the data sources 412(1) . . . 412(n), the communication network 410 as illustrated in FIG. 4 may be the same or similar to the EENELM 306, the server 304, the plurality of client devices 308(1)-308(n), the data sources 312(1) . . . 312(n), the communication network 310, respectively, as illustrated in FIG. 3.

According to exemplary use case of predicting supply and demand, the data sources 412(1) . . . 412(n) may include data sources for providing name mentions, e.g., company names, person names, etc., but the disclosure is not limited thereto.

According to exemplary embodiments, as illustrated in FIG. 4, the EENELM 406 may include a named entity recognition (NER) module 414, an entity embedding module 416, an entity vector validating module 418, an entity linking model training module 420, an entity linking model inference module 426, an entity linking service module 422, a character pattern learning module 424, a semantic pattern learning module 428, a communication module 430, and a GUI 432.

According to exemplary embodiments, each of the NER module 414, entity embedding module 416, entity vector validating module 418, entity linking model training module 420, entity linking model inference module 426, entity linking model service module 422, character pattern learning module 424, semantic pattern learning module 428, and the communication module 430 of the EENELM 406 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

According to exemplary embodiments, each of the NER module 414, entity embedding module 416, entity vector validating module 418, entity linking model training module 420, entity linking model inference module 426, entity linking model service module 422, character pattern learning module 424, semantic pattern learning model 428, and the communication module 430 of the EENELM 406 may be implemented by microprocessors or similar, and may be programmed using software (e.g., microcode) to perform various functions discussed herein and may optionally be driven by firmware and/or software.

Alternatively, according to exemplary embodiments, each of the NER module 414, entity embedding module 416, entity vector validating module 418, entity linking model training module 420, entity linking model inference module 426, entity linking model service module 422, character pattern learning module 424, semantic pattern learning model 428, and the communication module 430 of the EENELM 406 may be implemented by dedicated hardware, or as a combination of dedicated hardware to perform some functions and a processor (e.g., one or more programmed microprocessors and associated circuitry) to perform other functions.

According to exemplary embodiments, each of the NER module 414, entity embedding module 416, entity vector validating module 418, entity linking model training module 420, entity linking model inference module 426, entity linking model service module 422, character pattern learning module 424, semantic pattern learning model 428, and the communication module 430 of the EENELM 406 may be called via corresponding API.

According to exemplary embodiments, as illustrated in FIG. 4, the entity embedding module 416 may be configured to be utilized for entity embedding with triplet loss, but the disclosure is not limited thereto. According to exemplary embodiments, the entity linking model inference module 426 may be configured to be utilized for entity linking model inference, i.e., given a mention, the model will send back users a ranked list of candidate entities that might be linked to that mention, but the disclosure is not limited thereto.

According to exemplary embodiments, as illustrated in FIG. 4, the character pattern learning module 424 and the semantic pattern learning module 428 may be included within the entity linking training module 420.

The process may be executed via the communication module 430 and the communication network 410, which may comprise plural networks as described above. For example, in an exemplary embodiment, the various components of the EENELM 406 may communicate with the server 404, and the data sources 412(1) . . . 412(n) via the communication module 430 and the communication network 410. Of course, these embodiments are merely exemplary and are not limiting or exhaustive.

According to exemplary embodiments, the communication network 410 and the communication module 430 may be configured to establish a link between the data sources 412(1) . . . 412(n), the client devices 408(1)-408(n) and the EENELM 406, 506.

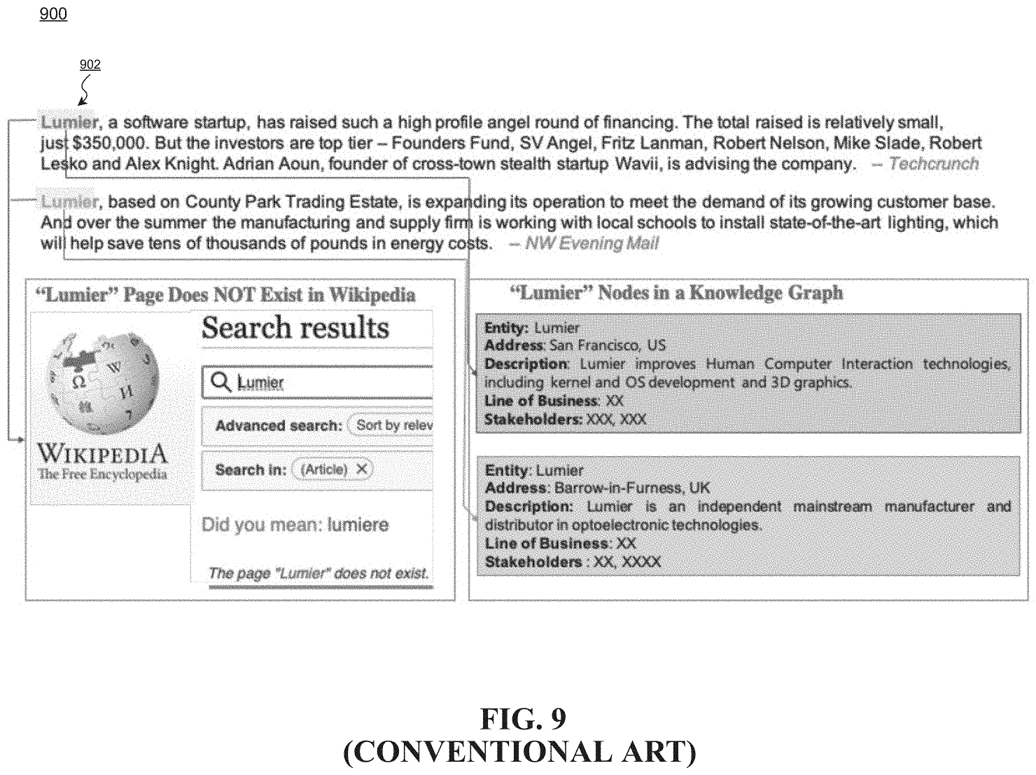

Knowledge graphs 411 may be utilized by the EENELM 406 for a wide range of applications from space, journalism, biomedicine to entertainment, network security, and pharmaceuticals. The EENELM 406 may also leverage the knowledge graphs 411 for financial applications such as risk management, supply chain analysis, strategy implementation, fraud detection, investment advice, etc. While leveraging a knowledge graph 411, Entity Linking (EL) is a central task for semantic text understanding and information extraction. In an EL task, the linking module 422 may link a potentially ambiguous mention (such as a company name) with its corresponding entity in a knowledge graph 411. EL can facilitate several knowledge graph applications, for example, the mentions of company names in the news are inherently ambiguous, and by relating such mentions with an internal knowledge graph (i.e., knowledge graph 411), the EENELM can generate valuable alerts for financial analysts. In FIG. 9, the conventional example 900 show a concrete example in which the name “Lumier” has been mentioned in two different news items. “Lumier”s are two different companies in the real world, and their positive financial activities should be brought to the attention of different stakeholders. With a successful EL engine implemented by the EENELM 406, these two mentions of “Lumier”s can be distinguished and linked to their corresponding entities in a knowledge graph 411.

Conventional EL has been driven by a number of standard datasets, such as CoNLYAGO, TAC KBP, DBpedia, and ACE, etc. These datasets are based on Wikipedia, and are therefore, naturally coherent, the well-structured and rich in context. Since Wikipedia does not cover all the entities of financial interest, the startup “Lumier” 902 mentioned in FIG. 9 is not present in Wikipedia, but it is of high financial interest as it has raised critical investment from famous investors.

To address the problems identified above, the EENELM 406 may be configured to link mentions of company names in text to entities in a knowledge graph 411. The models generated by the EENELM 406 makes the following advancements on the convention state-of-the-art, but the disclosure is not limited thereto. For example, the EENELM 406 does not rely on Wikipedia to generate entity embeddings. With minimum context information, the EENELM 406 can compute entity embeddings by training a margin loss function. The EENELM 406 can deploy a wide deep learning algorithm to match character and semantic information respectively. Unlike other deep learning models, the EENELM 406 applies a simple linear layer to learn character patterns, making the model more efficient both in the training phase and inference phase.

For example, referring to FIG. 4, according to exemplary embodiments, the NER module 414 may be configured to recognize or detect all named entity mentions from a plurality of data sources. The entity embedding module 416 may be configured to compute, in response to detecting, entity embeddings in a knowledge graph 411 by implementing context information and a margin-based loss function. The entity vector validating module 418 may be configured to validate the entity embeddings. The entity linking model training module 420 may be configured to train, in response to validating the entity embeddings, a machine learning model to match character and semantic information, respectively. The entity linking model inference module 426 may be configured to link, in response to deployment of the wide and deep learning model, the named mentions in text with corresponding entities in the knowledge graph 411. The entity linking service module 422 may be configured to present users with linked entities in knowledge graph 411.

According to exemplary embodiments, in deploying the machine learning model, the character pattern learning module 424 may be configured to apply a linear layer to learn character patterns.

According to exemplary embodiments, the entity embedding module 416 may be configured to implement a triplet loss model to generate the entity embeddings from pre-trained word embedding models.

According to exemplary embodiments, the entity linking model training module 420 may be configured to embed the mentions into vectors; and mathematically learn an entity linking model that can maximize similarities between the mentions and corresponding entity embeddings based on the vectors.

According to exemplary embodiments, the entity linking model inference module 426 may be further configured to implement a cosine similarity algorithm to measure similarities between each mention and corresponding entity embedding, but the disclosure is not limited thereto. For example, the entity linking model inference module 426 may be further configured to implement an Euclidean distance to measure similarities between each mention and corresponding entity embedding.

According to exemplary embodiments, the machine learning model may be a wide and deep learning model that may include a first long short-term memory (LSTM) neural network architecture configured to embed mentions from a first direction and a second LSTM neural network architecture configured to embed mentions from a second direction different from the first direction, but the disclosure is not limited thereto.

The EENELM 406 may assume that a knowledge graph (KG) 411 has a set of entities E. The EENELM 406 may further assume that W is the vocabulary of words in the input documents. An input document D is given as a sequence of words: D={w₁, w₂, . . . , w_{d}} where wₖ∈W,1≤k≤d. The output of an EL model is a list of T mention-entity pairs {(mᵢ, eᵢ)}_{i∈{1,T}}, where each mention is a word subsequence of D, mᵢ=wₗ . . . . , wᵣ, l≤r≤d, and each entity eᵢ∈E. The entity linking process implemented by the EENELM 406 may involve the following two steps, but the disclosure is not limited thereto. 1) Recognition. Recognize a list of mentions mᵢ as a set of all contiguous sequential words occurring in D that might mention some entity eᵢ∈E. The EENELM 406 adopted spaCy for mention recognition. 2) Linking. Given a mention mᵢ, and the set of candidate entities, C(mᵢ) such that |C(mᵢ)|>1, from the KG, choose the correct entity, eᵢ∈C(mᵢ), to which the mention should be linked.

For entity linking, the following techniques may be used by the EENELM 406: string matching, context similarity, machine learning classification, learning to rank, and deep learning.

String matching measures the similarity between the mention string and entity name string. The EENELM 406 experimented with different string matching methods for name matching, including Jaccard, Levenshtein, Ratcliff-Obershelp, Jaro Winkler, and N-Gram Cosine Similarity, and found that n-gram cosine similarity achieves the best performance on internal data. However, pure string-matching methods breakdown when two different entities share similar or the same name (as shown in FIG. 9) which motivates the need for better matching techniques.

Context Similarity methods compare similarities of respective context words for mentions and entities. The context words for a mention are the words surrounding it in the document. The context words for an entity are the words describing it in the KG. Similarity functions, such as Cosine Similarity or Jaccard Similarity, are commonly used to compare the two sets of context words, and then to decide whether a mention and an entity should be linked.

Many studies adopt machine learning techniques for the EL task. Binary classifiers, such as Naive Bayes, C4.5, Binary Logistic classifier, and Support Vector Machines (SVM), can be trained on mention-entity pairs to decide whether they should be linked.

Learn to rank methods may generate more than one mention-entity pairs. Learning to Rank (LTR) is a class of techniques that supplies supervised machine learning to solve ranking problems.

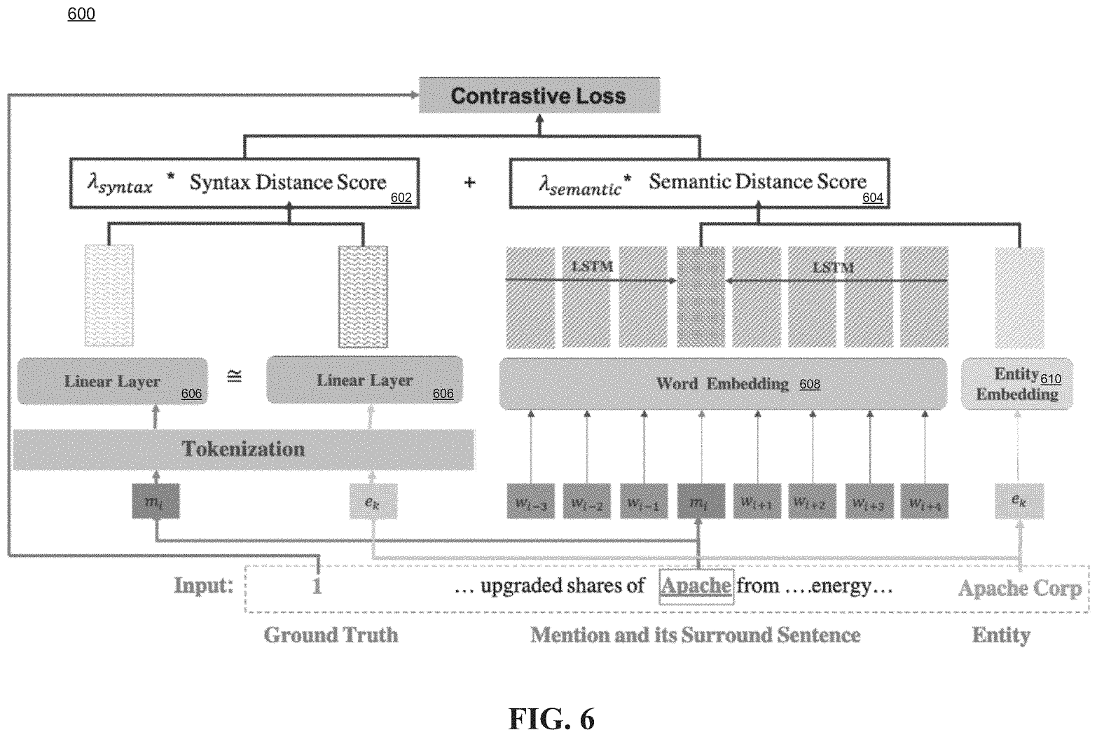

Deep learning has achieved success on numerous tasks including EL. Conventionally, techniques utilizes two levels of Bi-LSTM to embed characters into words, and words into mentions, and calculates the similarity between a mention vector and a pre-trained entity vector to decide whether they match. However, the techniques implemented by the EENELM 406 utilizes two shorter LSTMs to embed mention from two directions (as shown in FIG. 6), making the embedding more targeted with less parameters involved.

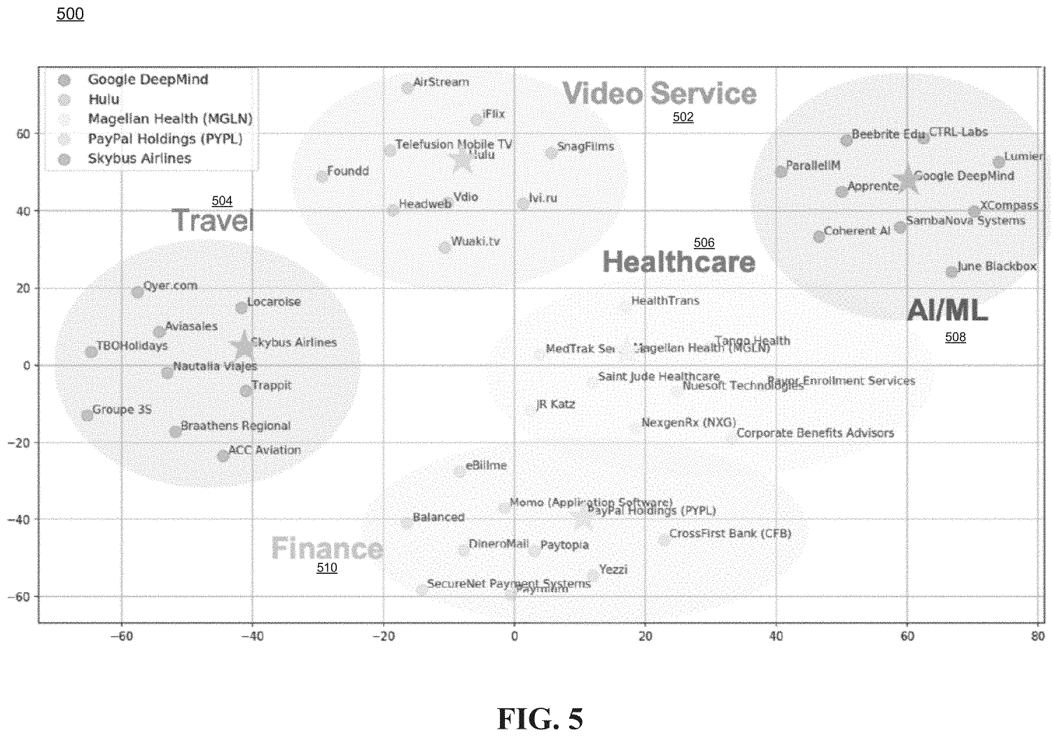

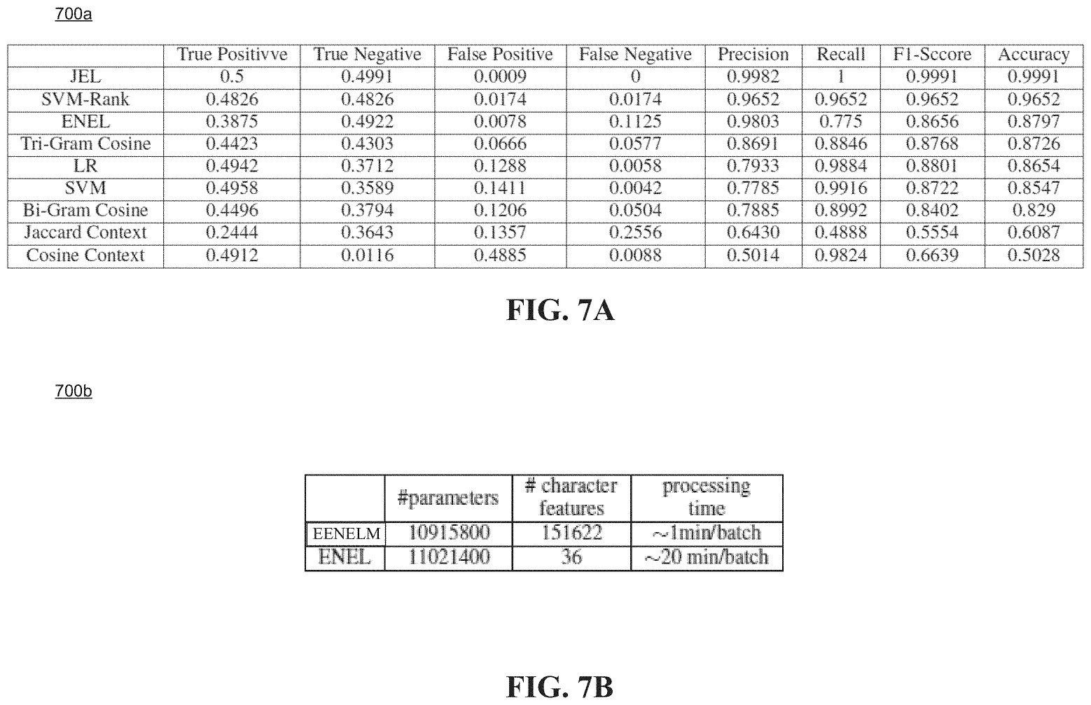

FIG. 5 illustrates an exemplary use case 500 of visualization and validation of entity embeddings implemented by the platform and language agnostic EENELM 406 of FIG. 4 in accordance with an exemplary embodiment. FIG. 6 illustrates an exemplary model framework 600 implemented by the platform and language agnostic EENELM 406 of FIG. 4 in accordance with an exemplary embodiment. FIG. 7A illustrates an exemplary table 700a illustrating performance comparison via precision and recall algorithm implemented by the platform and language agnostic EENELM 406 of FIG. 4 in accordance with an exemplary embodiment. FIG. 7B illustrates another exemplary table 700b of performance comparison via precision and recall algorithm implemented by the platform and language agnostic EENELM 406 of FIG. 4 in accordance with an exemplary embodiment.

Exemplary details of entity embedding techniques implemented by the EENELM 406 are described below referring to FIGS. 4, 5, 6, 7A, and 7B.

Most public entity embedding models are designed for Wikipedia pages and require rich entity description information. Each entity has a short description that is insufficient to support a solid statistical estimation of entity embeddings. To address this limitation, the EENELM 406 uses a Triplet Loss model to generate own entity embeddings from pre-trained word embedding models with limited context information support.

Entity Embedding Model. To prepare training data for this model, the EENELM 406 selects 10 words that can be used as positive examples and 10 words that can be used as negative example for each entity. To select the positive examples, the EENELM 406 scores each entity's description words with tf-idf, and select the words with 10 highest scores. To select the negative examples, the EENELM 406 randomly selects from words that do not appear in this entity's description. Thus, for each entity, the EENELM 406 can construct 10<entity, positive-word, negative-word>triplets to feed into triplet loss function formulated as Equation 1 below.

$$Loss = {\sum }_{i = 1}^{N} {[ {‖ {f}_{i}^{a} - {f}_{i}^{p} ‖}_{2}^{2} - {‖ {f}_{i}^{a} - {f}_{i}^{n} ‖}_{2}^{2} + α ]}_{+} \qquad ( 1 )$$

where fᵢ^{a} is the vector of an anchor that the EENELM 406 learn, fᵢ^{p} is the vector from a positive sample, and fᵢⁿ is the vector from a negative sample, α is the margin hyper-parameter to be manually defined. The EENELM 406 may train the entity embedding vectors (f^{a}). The EENELM 406 may utilize word embedding vectors (f^{p} and fⁿ) from a language model. In this exemplary experiment, α=2.0 led to the best performance.

Entity Embedding Validation. To validate the entity embeddings, the EENELM 406 may choose five seed companies from different industries—“Google DeepMind”, “Hulu”, “Magellan Health”, “PayPal Holdings”, “Skybus Airlines”. The EENELM 406 next selects their ten nearest neighbors (as shown in FIG. 5). The EENELM 406 calculates a t-Distributed Stochastic Neighbor Embedding (t-SNE) to project the embeddings into a 2-dimension space. As illustrated in FIG. 5, five seed companies from different industries are clearly separated in space. For “Google DeepMind”, the EENELM 406 can find that all its neighbors are, as expected, Artificial Intelligence and Machine Learning (AI/ML) companies 508. This visualization on the GUI 432 gives one a sanity check for our entity embeddings. For example, FIG. 5 illustrates video service 502, travel 504, health care 506, and AI/ML 508.

Entity Linking

Two factors may affect an EL model's performance: Characters and Semantics.

According to exemplary embodiments, character “Lumier” (as illustrated in FIG. 9) may be easily distinguished from “ParallelM” because they have completely different character patterns. These patterns can be easily captured by a wide and shallow linear model.

According to exemplary embodiments, for semantics, “Lumier (Software)” (as illustrated in FIG. 9) can be distinguished from “Lumier (LED)” because they have different semantic meanings behind the same name. These semantic differences can be captured by a deep learning model.

To combine the two important factors listed above, the EENELM 406 develops a wide and deep learning model for EL task (shown in FIG. 6).

Wide Character Learning. Unlike many other conventional approaches that apply character embeddings to incorporate lexical information, the EENELM 406 applies a wide but shallow linear layer for the following two reasons. First, embedding aims to capture an item's semantic meanings, but characters naturally have no such semantics. “A” in “Amazon” does not have any relationship with “A” in “Apple”. Second, as embedding layer involves more parameters to optimize, it is much slower in training and inference than a simple linear layer.

Feature Engineering. Many mentions of an entity exhibit a complex morphological structure that is hard to account for by simple word-to-word or character-to-character matching. Subwords can improve matching accuracy dramatically. Given a string, the EENELM 406 undertakes the following processing to maximize morphological information the EENELM 406 can get from subwords, but the disclosure is not limited thereto. 1) Clean a string, convert it to lower case, remove punctuation, standardize suffix, etc. For example, “PayPal Holdings, Inc.” will change to “paypalhlds”. 2) Pad the start and end of the string; “paypalhlds” will be converted to “*paypalhlds*”. 3) Apply multiple levels of n-gram (n∈[2,5]) segmentation;“*paylpalhlds*” will be {*p, ay, . . . , lhlds, hlds*}. 4) Append original words, *paypal* and *hlds*, to the token list.

Wide Character Learning. The EENELM 406 may be configured to apply a Linear Siamese Network for wide character learning. According to exemplary embodiments, the EENELM 406 may implement two identical linear layers with shared weights (as shown in the left part of FIG. 6). With this architecture, similar inputs, Tₘ and Tₑ, will generate similar outputs, Yₘ and Yₑ. The EENELM 406 applied the Euclidean distance to estimate output's similarity. See equation 2 below.

$${D}_{sma} = f ( {Y}_{m} , {Y}_{e} ) = \sqrt{{\sum }_{i = 1}^{n} {( {Y}_{{m}_{i}} - {Y}_{{e}_{i}} )}^{2}} \qquad ( 2 )$$

Deep Semantic Embedding. The EENELM 406 may be configured to embed the mentions into vectors so that the EENELM 406 can mathematically measure similarities between them and entity embeddings. The EENELM 406 may use LSTM to embed mentions from their context. Instead of using a Bi-LSTM over the whole context, the EENELM 406 may apply two shorter LSTMs to embed mention from two directions (as shown in FIG. 6), making the embedding more targeted with less parameters involved. For example, FIG. 6 illustrates syntax distance score 602, semantic distance score 604, linear layer 606, word embedding 608, entity embedding 610, etc.

Given a mention mₜ, the EENELM 406 may treat its left n words {wₜ₋ₙ, . . . , wₜ₋ₗ, wₜ} (mention words included) and its left context, and right n words {wₜ, wₜ₊ₗ, . . . , wₜ₊ₙ} as its right context (mention words included). See equation 3 below.

hₜ^{l}=\vec{LSTM}(wₜ₋₁^{l},wₜ)

hₜ^{r}= [symbol] (wₜ₊₁^{r},wₜ) (3)

In addition to LSTM, the EENELM 406 may apply an attention layer to distinguish the influence of words. The EENELM 406 may multiply last layer's output from LSTM {xᵢ, . . . , xⱼ} with attention weights, and get a context representation v. See formula 4 below.

$${α}_{k} = < {w}_{α} , {x}_{k} > \\ {α}_{k} = \frac{exp ( {α}_{k} )}{{\sum }_{n = i}^{j} exp ( {α}_{k} )} \\ g = {\sum }_{k = i}^{j} {α}_{k} {x}_{k} \qquad ( 4 )$$

Thus, the EENELM 406 may be configured to form a mention's vector by concatenating its left and right context representations, gₗ and g_{r:}

gₘ=[gₜ:gᵣ]

Vₘ=FC(gₘ) (5)

where FC is a fully connected feed-forward neural network. When the EENELM 406 gets the mention embedding Vₘ, given a pre-trained entity embedding vector Vₑ, the EENELM 406 can calculate similarity between these two vectors based on Euclidean distance. See equation 6 below.

$${D}_{sma} = d ( {V}_{m} , {V}_{e} ) = \sqrt{{\sum }_{i = 1}^{n} {( {V}_{{m}_{i}} - {V}_{{e}_{i}} )}^{2}} \qquad ( 6 )$$

Contrastive Loss Function: The EENELM 406 may combine both D_{syx} and D_{smc} as our target to train the model. The final distance is defined as:

D_{W}=λ_{syx}D_{syx}+λ_{smc}D_{smc} (7)

Then, the EENELM 406 may apply a contrastive loss function to formulate our object loss function.

L=(Y)½(D_{W})²+(1−Y)½{max(0,m−D_{W})}² (8)

where Y is the ground truth value, where a value of 1 indicates that mention m and entity e is matched, 0 otherwise.

According to exemplary embodiments, in data preparation, the EENELM 406 first may apply spaCy over financial news to detect all the named entity mentions. SpaCy features neural models for named entity recognition (NER). By considering text capitalization and context information, spaCy claims an accuracy above 85% for NER. The EENELM 406 used it on financial news to recognize all the critical mentions that are tagged with “ORG”. The data preparation processes implemented by the EENELM 406 may be as follows, but the disclosure is not limited thereto: 1) the EENELM 406 extracts mentions from the financial news with spaCy; 2) The EENELM 406 applies bi-gram cosine similarity between the extracted mentions and company names in our internal knowledge graph (i.e., knowledge graph 411); 3) if the similarity score between a mention string and an entity name is smaller than 0.5, the EENELM 406 treats that as a strong signal that the two are not linked, and marked them as 0; 4) if the similarity score between a mention string and an entity name is equal to 1.0, the EENELM 406 manually checks the list to avoid instances that two different entities share the same name (infrequent), and marked the pair as 1.

According to exemplary embodiments, 5) if a mention and an entity name have cosine similarity larger than 0.75, but smaller than 1.0, the EENELM 406 manually labels the followings, but the disclosure is not limited thereto.

(a) Some cases are easy to tell, such as: “Luminet” vs “Luminex”, the EENELM 406 labeled those instances as 0 directly.

(b) Some cases can be decided according to their description/context. The EENELM 406 printed mention's context information and entity's description respectively, and made the decision based on those texts, such as “Apple” vs “Apple Corps.”

(c) Some other cases need help from publicly information found through internet search to decide, such as “Apollo Management” vs “Apollo Global Management”.

According to exemplary embodiments, 6) if a mention and an entity name have cosine similarity between 0.5 and 0.75, the EENELM 406 discards it.

Negative examples from step 3 may make the dataset very imbalanced containing many more negative pairs. Thus, according to exemplary embodiments, 7) the EENELM 406 may count the number of examples obtained in steps 4 and 5, and randomly samples a comparable number from the examples gathered in step 3.

According to exemplary use case, in total, the EENELM 406 have labeled 586,975 ground truth mention-entity pairs, with 293,949 positive mention-entity pairs, and 293,026 negative pairs. The EENELM 406 may split 80% of the data as training data, 10% as validation data, and 10% as testing data.

According to exemplary embodiments, in string matching, the EENELM 406 may chose Bi-Gram and Tri-Gram Cosine Similarity as two of baselines. Before similarity calculation, all tokens are weighted with tf-idf scores. The EENELM 406 may set 0.8 as the threshold.

According to exemplary embodiments, in context similarity, the EENELM 406 used Jaccard and Cosine similarity to measure the similarities between mention context and entity descriptions. A potential matched mention-entity pair should share at least one context word.

According to exemplary embodiments, in classification, the EENELM 406 may choose Logistic Regression (LR) and SVM for experiments. The EENELM 406 may be configured to generate from received the following data, but the disclosure is not limited thereto. StrSimSurface: edit-distance among mention strings and entity names; ExactEqualSurface: number of overlapped lemmatized words in mention strings and entity names; TFSimContext: TF-IDF similarity between mention's context and entity's description; WordNumMatch: the number of overlapped lemmatized words between mention's context and entity's description.

According to exemplary embodiments, in Learn to Rank, the EENELM 406 may utilize SVM-RANK as the representation of Learn to Rank. The EENELM 406 adopted the same features as defined above.

According to exemplary embodiments, in compassion and accuracy determination, the EENELM 406 first compares the methods with precision and recall algorithm. For an easier comparison, the EENELM 406 scaled each of True Positive, True Negative, False Positive, and False Negative into [0,0.5] showing as following.

$$True Positive = \frac{Count ( Predict = 1 \& Truth = 1 )}{2 \times Count ( Truth = 1 )}$$

$$True Negative = \frac{Count ( Predict = 0 \& Truth = 0 )}{2 \times Count ( Truth = 0 )}$$

$$False Positive = \frac{Count ( Predict = 1 \& Truth = 0 )}{2 \times Count ( Truth = 0 )}$$

$$Flase Negative = \frac{Count ( Predict = 0 \& Truth = 1 )}{2 \times Count ( Truth = 1 )}$$

$$The result is shown in TABLE 1 , in which \text{:}$$

$$Precision = \frac{True Positive}{True Positive + False Positive}$$

$$Recall = \frac{True Positive}{True Positive + False Negative}$$

$$F 1 \text{-} Score = 2 \times \frac{Precision \times Recall}{Precision + Recall}$$

$$Accuracy = True Positive + True Negative$$

From Table 700a as illustrated in FIG. 7a, the EENELM 406 finds context based methods perform poorly as expected. Descriptions in the knowledge graph 411 have very different wording styles from financial news. Simply comparing context words will definitely result in low accuracy. SVM-Rank surprisingly outperforms ENEL. The reason here is that ENEL does not model character features properly. In SVM-Rank, the EENELM 406 have carefully designed character features, (e.g., edit distance and tf-idf similarity), but ENEL just embeds 36 single character embeddings. This result also indicates that without good character learning, even deep learning could not solve the linking problem well.

According to exemplary embodiments, the EENELM 406 outperforms ENEL. First, the EENELM 406 involves more character features. ENEL just embeds 36 characters (26 letters+10 digits), but EENELM 406 computes 151622 character features (as shown in Table 2). This configuration supports EENELM 406 with a better performance in capturing character patterns. For example, EENELM 406 could successfully link “Salarius Pharm LLC” to “Salarius Pharmaceuticals” but ENEL missed this link. Second, ENEL jointly embeds all characters and words from context and mention itself into a mention's vector, and minimizes the distance between this mention vector and a pre-trained entity embedding vector. However, the entity embeddings themselves are generated without character information. Character embeddings in ENEL, especially character embeddings from context words, somehow add noise to semantic embeddings, and impact final performance. In addition, Table 700b as illustrated in FIG. 7B gives a brief overview of efficiency comparison between EENELM 406 and ENEL. Although EENELM 406 and ENEL share similar number of parameters, EENELM 406 trains faster than ENEL. EENELM 406 utilizes linear layers to learn character patterns, which is easier to learn than an embedding layer in ENEL.

According to exemplary embodiments a large-scale knowledge graph 411 is implemented by the EENELM 406. The knowledge graph 411 may integrate data from third party providers with internal data created in house. The system implemented by the EENELM 406 may contain several million entities (e.g. suppliers, investors, etc.) and several million links (e.g. supply chain, investment, etc.) among those entities.

According to an exemplary use case, it can be assumed that “Acma Retail Inc” filed for bankruptcy due to the pandemic, and a lot of clients could feel stress as they are suppliers to Acma. Such stress can pass deep down into its supply chain and trigger financial difficulties for other clients. An organization having those clients may face different levels of risks from suppliers with different orders in Acma's supply chain. With “Acma” mentioned in financial news linked with “Acma Global Retail Inc” in the knowledge graph 411 (distinguished from “Acma Furniture, LLC”, “Acma Enterprise System”, etc.), the EENELM 406 can accurately track down Acma supply chain, identify stressed suppliers with different revenue exposure, and measure our primary risk due to Acma's bankruptcy. Once stressed clients with significant exposure are detected, alerts can be sent out to corresponding credit officers by the EENELM 406. If “Acma” was linked with incorrect entities, it will result in too many false signals, resulting in wasted effort, but the EENELM 406 efficiently can handle that situation.

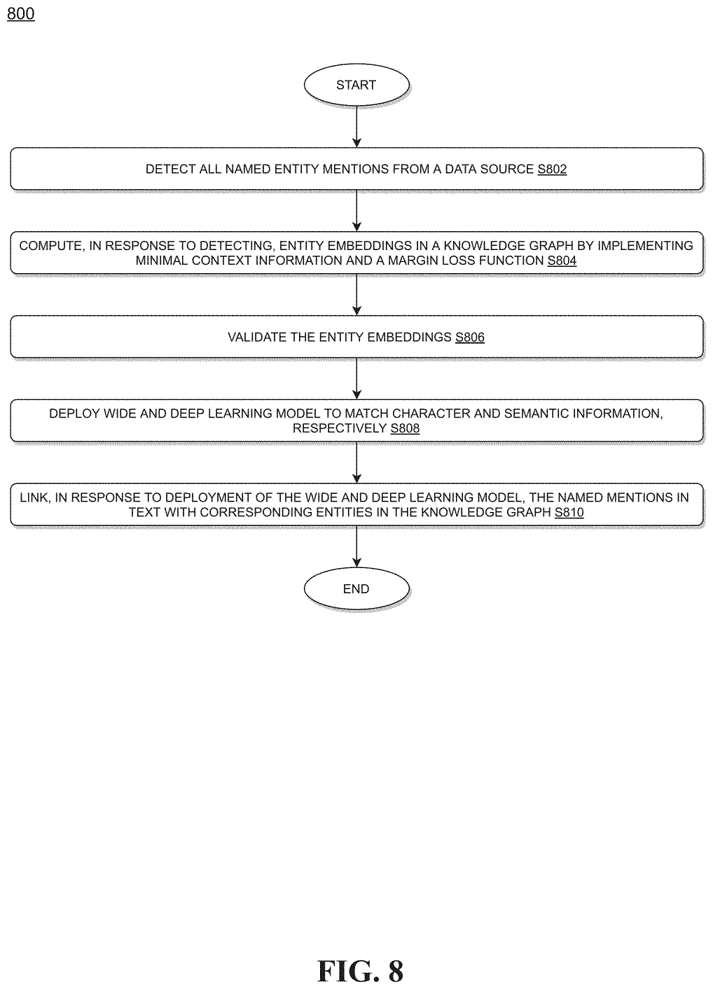

FIG. 8 illustrates a flow chart 800 for generating entity embeddings, and utilizing a machine learning model to match character and semantic information respectively, in accordance with an exemplary embodiment. It will be appreciated that the illustrated process 500 and associated steps may be performed in a different order, with illustrated steps omitted, with additional steps added, or with a combination of reordered, combined, omitted, or additional steps.

As illustrated in FIG. 8, at step S802, the process 800 may include detecting all named entity mentions from a plurality of data sources. At step S804, the process 800 may include computing, in response to detecting, entity embeddings in a knowledge graph by implementing context information and a margin-based loss function. At step S806, the process 800 may include validating the entity embeddings. At step S808, and the process 800 may include deploying, in response to validating the entity embeddings, a machine learning model to match character and semantic information, respectively. At step S810, the process 800 may include linking, in response to deployment of the wide and deep learning model, the named mentions in text with corresponding entities in the knowledge graph.

According to exemplary embodiments, in deploying the machine learning model, the process 800 may further include: applying a linear layer to learn character patterns.

According to exemplary embodiments, the process 800 may further include: implementing a triplet loss model to generate the entity embeddings from pre-trained word embedding models.

According to exemplary embodiments, the process 800 may further include: embedding the mentions into vectors; and mathematically measuring similarities between the mentions and corresponding entity embeddings based on the vectors.

According to exemplary embodiments, the process 800 may further include: implementing a cosine similarity algorithm to measure similarities between each mention and corresponding entity embedding.

According to exemplary embodiments, in the process 800, the machine learning model may be a wide and deep learning model but the disclosure is not limited thereto.

According to exemplary embodiments, in the process 800, the wide and deep learning model may include a first long short-term memory (LSTM) neural network architecture configured to embed mentions from a first direction and a second LSTM neural network architecture configured to embed mentions from a second direction different from the first direction, but the disclosure is not limited thereto.

According to exemplary embodiments, the EENELD 402 may include a memory (e.g., a memory 106 as illustrated in FIG. 1) which may be a non-transitory computer readable medium that may be configured to store instructions for implementing an EENELM 406 for generating entity embeddings, and utilizing a machine learning model (i.e., deep learning model) to match character and semantic information respectively as disclosed herein. The EENELD 402 may also include a medium reader (e.g., a medium reader 112 as illustrated in FIG. 1) which may be configured to read any one or more sets of instructions, e.g., software, from any of the memories described herein. The instructions, when executed by a processor embedded within the EENELM 406 or within the EENELD 402, may be used to perform one or more of the methods and processes as described herein. In a particular embodiment, the instructions may reside completely, or at least partially, within the memory 106, the medium reader 112, and/or the processor 104 (see FIG. 1) during execution by the EENELD 402.

According to exemplary embodiments, the instructions, when executed, may cause a processor embedded within the EENELM 406 or the EENELD 402 to perform the following: detecting all named entity mentions from a plurality of data sources; computing, in response to detecting, entity embeddings in a knowledge graph 411 by implementing context information and a margin-based loss function; validating the entity embeddings; deploying, in response to validating the entity embeddings, a machine learning model to match character and semantic information, respectively; and linking, in response to deployment of the wide and deep learning model, the named mentions in text with corresponding entities in the knowledge graph 411. The processor may be the same or similar to the processor 104 as illustrated in FIG. 1 or the processor embedded within EENELD 202, EENELD 302, EENELD 402, and EENELM 406.

According to exemplary embodiments, in deploying the machine learning model, the instructions, when executed, may cause a processor 104 to perform the following: applying a linear layer to learn character patterns.

According to exemplary embodiments, the instructions, when executed, may cause a processor 104 to perform the following: implementing a triplet loss model to generate the entity embeddings from pre-trained word embedding models.

According to exemplary embodiments, the instructions, when executed, may cause a processor 104 to perform the following: embedding the mentions into vectors; and mathematically measuring similarities between the mentions and corresponding entity embeddings based on the vectors.

According to exemplary embodiments, the instructions, when executed, may cause a processor 104 to perform the following: implementing a cosine similarity algorithm to measure similarities between each mention and corresponding entity embedding.

According to exemplary embodiments as disclosed above in FIGS. 1-8, technical improvements effected by the instant disclosure may include a platform that may also provide optimized processes of implementing a platform and language agnostic end-to-end neural entity linking module configured for generating entity embeddings, and utilizing a machine learning model (i.e., deep learning model) to match character and semantic information respectively, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for end-to-end neural entity linking by utilizing one or more processors and one or more memories, the method comprising:
detecting all named entity mentions from a plurality of data sources;
computing, in response to detecting, entity embeddings in a knowledge graph by implementing context information and a margin-based loss function;
validating the entity embeddings;
deploying, in response to validating the entity embeddings, a machine learning model to match character and semantic information, respectively; and
linking, in response to deployment of the wide and deep learning model, the named mentions in text with corresponding entities in the knowledge graph.

2. The method according to claim 1, wherein in deploying the machine learning model, the method further comprising:
applying a linear layer to learn character patterns.

3. The method according to claim 1, further comprising:
implementing a triplet loss model to generate the entity embeddings from pre-trained word embedding models.

4. The method according to claim 1, further comprising:
embedding the mentions into vectors; and
mathematically measuring similarities between the mentions and corresponding entity embeddings based on the vectors.

5. The method according to claim 4, further comprising:
implementing a cosine similarity algorithm to measure similarities between each mention and corresponding entity embedding.

6. The method according to claim 1, wherein the machine learning model is a wide and deep learning model.

7. The method according to claim 6, wherein the wide and deep learning model includes a first long short-term memory (LSTM) neural network architecture configured to embed mentions from a first direction and a second LSTM neural network architecture configured to embed mentions from a second direction different from the first direction.

8. A system for end-to-end neural entity linking, the system comprising:
a processor; and
a memory operatively connected to the processor via a communication interface, the memory storing computer readable instructions, when executed, causes the processor to:
detect all named entity mentions from a plurality of data sources;
compute, in response to detecting, entity embeddings in a knowledge graph by implementing context information and a margin-based loss function;
validate the entity embeddings;
deploy, in response to validating the entity embeddings, a machine learning model to match character and semantic information, respectively; and
link, in response to deployment of the wide and deep learning model, the named mentions in text with corresponding entities in the knowledge graph.

9. The system according to claim 8, wherein in deploying the machine learning model, the processor is further configured to:
apply a linear layer to learn character patterns.

10. The system according to claim 8, wherein the processor is further configured to:
implement a triplet loss model to generate the entity embeddings from pre-trained word embedding models.

11. The system according to claim 8, wherein the processor is further configured to:
embed the mentions into vectors; and
mathematically measure similarities between the mentions and corresponding entity embeddings based on the vectors.

12. The system according to claim 11, wherein the processor is further configured to:
implement a cosine similarity algorithm to measure similarities between each mention and corresponding entity embedding.

13. The system according to claim 8, wherein the machine learning model is a wide and deep learning model.

14. The system according to claim 13, wherein the wide and deep learning model includes a first long short-term memory (LSTM) neural network architecture configured to embed mentions from a first direction and a second LSTM neural network architecture configured to embed mentions from a second direction different from the first direction.

15. A non-transitory computer readable medium configured to store instructions for end-to-end neural entity linking, wherein, when executed, the instructions cause a processor to perform the following:
detecting all named entity mentions from a plurality of data sources;
computing, in response to detecting, entity embeddings in a knowledge graph by implementing context information and a margin-based loss function;
validating the entity embeddings;
deploying, in response to validating the entity embeddings, a machine learning model to match character and semantic information, respectively; and
linking, in response to deployment of the wide and deep learning model, the named mentions in text with corresponding entities in the knowledge graph.

16. The non-transitory computer readable medium according to claim 15, wherein in deploying the machine learning model, when executed, the instructions further cause the processor to perform the following:
applying a linear layer to learn character patterns.

17. The non-transitory computer readable medium according to claim 15, wherein, when executed, the instructions further cause the processor to perform the following:
implementing a triplet loss model to generate the entity embeddings from pre-trained word embedding models.

18. The non-transitory computer readable medium according to claim 15, wherein, when executed, the instructions further cause the processor to perform the following:
embedding the mentions into vectors; and
mathematically measuring similarities between the mentions and corresponding entity embeddings based on the vectors.

19. The non-transitory computer readable medium according to claim 18, wherein, when executed, the instructions further cause the processor to perform the following:
implementing a cosine similarity algorithm to measure similarities between each mention and corresponding entity embedding.

20. The non-transitory computer readable medium according to claim 15, wherein the machine learning model is a wide and deep learning model that includes a first long short-term memory (LSTM) neural network architecture configured to embed mentions from a first direction and a second LSTM neural network architecture configured to embed mentions from a second direction different from the first direction.
